(19) United States
(12) Patent Application Publication
(10) Pub. No.: US 2024/0191942 A1
(43) Pub. Date: Jun. 13, 2024

(54) METHOD AND APPARATUS FOR DRYING FOODSTUFF

(71) Applicant: THE REGENTS OF THE UNIVERSITY OF CALIFORNIA, Oakland, CA (US)

(72) Inventors: Stefano Foresti, Denair, CA (US); Alejandro Gutierrez, Merced, CA (US)

(73) Assignee: THE REGENTS OF THE UNIVERSITY OF CALIFORNIA, Oakland, CA (US)

(21) Appl. No.: 18/537,738

(22) Filed: Dec. 12, 2023

Related U.S. Application Data
(60) Provisional application No. 63/387,282, filed on Dec. 13, 2022.

(51) Int. Cl. F26B 3/06; F26B 21/00

(52) U.S. Cl. CPC F26B 3/06; F26B 21/006; F26B 2200/06

(57) ABSTRACT

Methods and apparatus for drying foodstuff such as nuts, fruits, and vegetables above ground with natural airflow that is typical during the drying season. The apparatus can be configured for placement with a container or integrated into the interior of a container, such as stationary containers, moveable containers, trailer containers, above-ground containers, and containers with sidewalls through which air can flow.

### CROSS-REFERENCE TO RELATED APPLICATIONS

This application claims priority to, and the benefit of, U.S. provisional patent application serial number 63/387,282 filed on Dec. 13, 2022, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to drying foodstuff, and more particularly to the off-ground drying of tree nuts, including, but not limited to, almonds.

### 2. Background Discussion

Current methods to harvest almonds typically involve the following steps and related equipment:
1. shaking a tree, so the tree nuts fall on the ground;
2. sweeping the nuts, so they gather in a row at the center between two rows of trees;
3. leaving the nuts on the ground in the row to allow the nut hulls to dry (for about a week);
4. gathering the nuts with a “harvester”; and
5. loading the nuts in trailers for transportation to a huller.

The almond industry is aware of the dust generated during harvest (due to steps 2 and 4 above) and consequently has designated the reduction of harvest dust by 50% as an industry goal. Accordingly, the industry has developed off-ground harvesting equipment where steps 1, 2, and 4 above are consolidated and performed by one piece of equipment. However, the drying time of step 3 is also eliminated, which poses a problem at the hulling and shelling stage that requires nuts to arrive already dried. Currently, the off-ground harvesting equipment is used in two ways:
(a) consolidating steps 1 and 2 above, still leaving the almonds to dry, and later performing step 4; and
(b) performing steps 1, 2, and 4 at once, and moving the nuts for drying elsewhere.

Furthermore, these are several ways that can be used for drying almonds which include:
(a) moving almonds to a different open sunny area for drying on the ground; however, this approach requires very large spaces that are unavailable or too expensive for farming operations, and may not completely reduce dust. There is also a high risk for pathogens, mold, fungus, and other diseases;
(b) using dryers similar to those used for other fruit drying; however, such dryers are very expensive to run (due to energy requirements), and would not scale up to the three billion pounds of almonds produced yearly in California;
(c) drying in containers or bins; however, this method has shown that internal heat is produced and the fruit may rot.

Therefore, there is a need for a method and apparatus for drying almonds that overcomes the foregoing shortfalls of current drying approaches.

### BRIEF SUMMARY

This disclosure describes methods and apparatus for drying foodstuff such as nuts, fruits, and vegetables above ground with natural warm airflow that is typical during the drying season, without supplemental heat or forced air convection. However, drying can be supplemented with heat, blowers, or convection if desired.

In one embodiment the apparatus is configured to be placed within a container. In another embodiment the apparatus is integrated into the interior of a container. In one embodiment the apparatus comprises a support frame formed from a plurality of spaced apart support rails, and a plurality of spaced apart radiator panels coupled to the support rails in a configuration that forms compartments between the radiator panels. In use, the compartments are filled with foodstuff for drying. The radiator panels have openings through which air can flow, such that the foodstuff is dried by natural warm airflow. In colder, or more humid ambient conditions, externally heated air may be used.

The apparatus can be used with various containers, such as, for example, stationary containers, moveable containers, trailer containers, above-ground containers, and containers with sidewalls through which air can flow.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is one embodiment of a dryer that may be formed from multiple modular and portable parts.

FIG. 2 illustrates an individual radiator having a plurality of apertures.

FIG. 3 illustrates the radiator having a plurality of vertical slits.

FIG. 4 illustrates the radiator having a plurality of horizontal slits.

FIG. 5 illustrates the radiator having a mesh, with two lifting attachment points.

FIG. 6 shows that a nut dryer may be placed within an interior opening of a trailer housing to receive nuts to be dried.

FIG. 7 illustrates another example embodiment of the nut dryer in a trailer.

FIG. 8 illustrates an example embodiment of loading nuts into a trailer having a nut dryer.

FIG. 9 is an illustration of an example embodiment of drying nuts loaded into a trailer.

FIG. 10 is an illustration of an example embodiment of a removable and reusable nut dryer.

FIG. 11 illustrates a flowcharted example method for dying nuts according to the presented technology.

FIG. 12 is an illustration of an embodiment of a nut dryer assembled in the interior cavity of a trailer.

FIG. 13 illustrates an end view of the trailer illustrated in FIG. 12.

FIG. 14 illustrates a flowchart of an example method for drying produce according to the presented technology.

FIG. 15 shows that the nut dryer shows similarity to the nut dryer illustrated in FIG. 12.

FIG. 16 is a cross sectional view of FIG. 15.

FIG. 17 illustrates an example embodiment of an on-ground aeration apparatus according to the presented technology.

FIG. 18 illustrates an example use of the on-ground aeration apparatus of FIG. 17.

FIG. 19 is a side view of a trailer aeration system for natural almond drying, utilizing pulled (or pushed) aeration for foodstuff drying.

FIG. 20 is a top view of the trailer aeration system for natural almond drying demonstrating two different types of apertures to allow for air flow, while still restricting movement of almonds through the aeration apertures.

FIG. 21 is a front view of the trailer aeration system for natural almond drying, which also provides for heating of the ambient air.

FIG. 22 is a side view of a trailer aeration system for natural almond drying utilizing pulled (or pushed) aeration for foodstuff drying.

FIG. 23 is an illustration of a nut dryer utilizing an external hose fed aeration system.

FIG. 24 is an exploded view of still another embodiment of a foodstuff drying apparatus using an internal aeration system.

### DETAILED DESCRIPTION

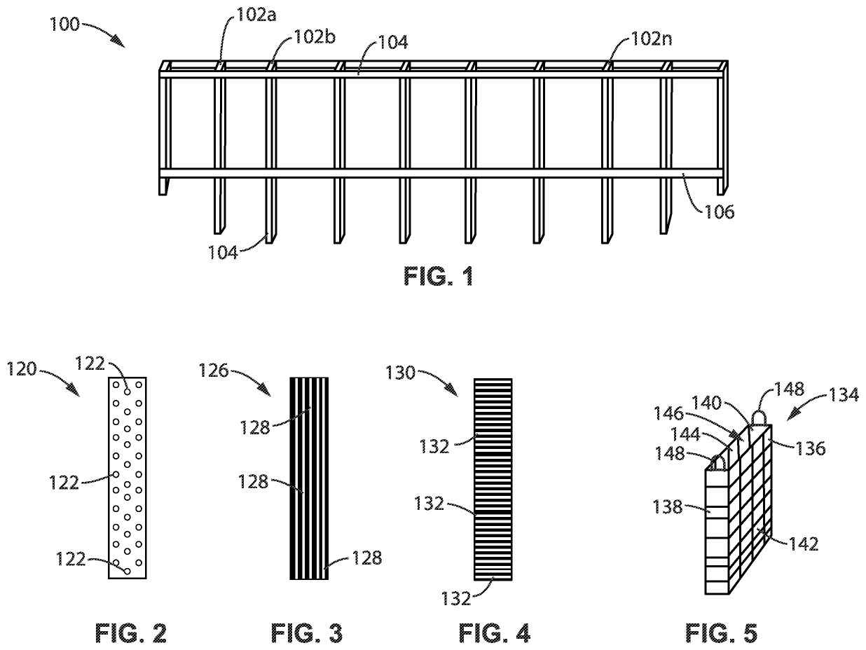

Referring to FIG. 1 through FIG. 5, an exemplary embodiment of a nut dryer apparatus according to the technology of this disclosure is illustrated. As shown in FIG. 1, the nut dryer 100 may be formed from multiple modular and portable parts that may be connected in any known manner and desired design as further discussed below. The nut dryer 100 may include a plurality of radiators 102a, 102b, 102n (where n is a letter). The radiators 102a . . . 102n may be supported by at least one support bracket 104 removably coupled to the outer edge 106 of each of the plurality of radiators 102a . . . . 102n.

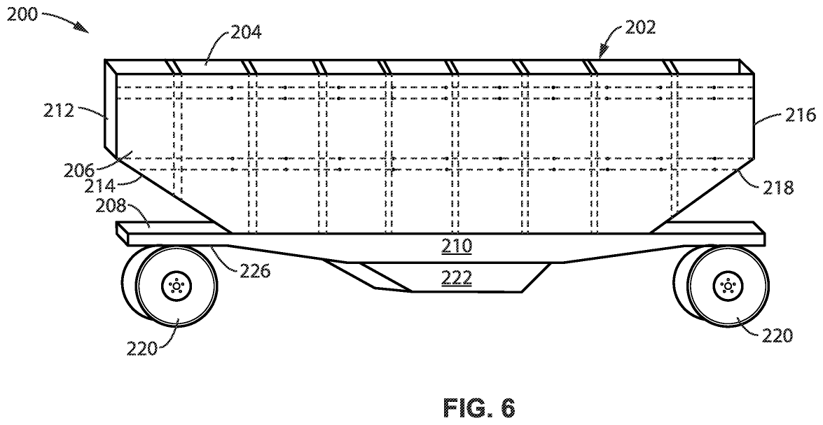

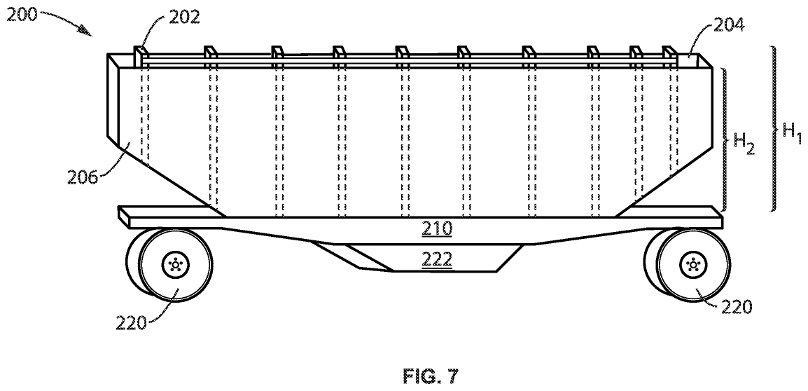

The support brackets 104 may be mechanically and removably secured to the outer edge 106 through any known means such with the use of various hardware or fastening members such as nuts, bolts, and screws, as well as other means with the use of other fasteners, brackets, hinges, grooves, tracks, and other similar means or methods. The radiators 102a . . . 102n and support brackets 104 may be made from any known material that is strong and sturdy to withstand any type of weather as well as large amounts of force such as metal, steel, aluminum, iron, copper, brass, plastic, and the like. The radiators 102a . . . 102n may be any desired length to fit into a trailer as further described below, for example, in FIG. 6 and FIG. 7.

The radiators 102a . . . 102n and support brackets 104 may be removably coupled to each other for ease of assembly, disassembly, and installation into a trailer. This allows for the nut dryer 100 to be retrofitted into existing trailers. In another embodiment, radiators 102a . . . 102n and support brackets 104 may be permanently coupled to each other if new trailers are manufactured having nut dryer 100 installed into the interior of the trailer. In this embodiment, radiators 102a . . . 102n and support brackets 104 may be permanently coupled to each other using any known method such as welding, use of rivets, adhesives, and similar methods. Either embodiment allows for a customized design of the nut dryer to be inserted into any desired cavity or opening.

Nut drier 100 may be used to dry any type of nuts, such as almonds, pecans, walnuts, and the like. The nut drier 100 may also be used to dry any types of produce, such as fruits or vegetables.

FIG. 2 through FIG. 5 illustrate example embodiments of the radiators 102a . . . 102n. FIG. 2 illustrates an individual radiator 120 having a plurality of apertures 122. The apertures 122 may be of any desired diameter that allows air flow through the radiator 120. In one example, the diameter of the aperture 122 may be between about 0.1 to about 2 inches. In another example, the diameter of the aperture 122 may be between about 0.1 to about 5 inches. In still another example, the diameter of the aperture 122 may be between about 0.1 to about 10 inches.

Refer now to FIG. 3 and FIG. 4. FIG. 3 illustrates the radiator 126 having a plurality of vertical slits 128. FIG. 4 illustrates the radiator 130 having a plurality of horizontal slits 132. The plurality of horizontal slits 132 and the plurality of vertical slits 128 may be any desired width that allows air flow through the respective radiator 126, 130. In one example, the width of the vertical slits 128, or horizontal slits 132 may be between about 0.1 to about 2 inches. In another example, the width of the vertical slits 128, or horizontal slits 132 may be between about 0.1 to about 5 inches In still another example, the width of the vertical slits 128, or horizontal slits 132 may be between about 0.1 to about 10 inches.

FIG. 5 illustrates an orthographic view of an example embodiment of a radiator 134. In this embodiment, the radiator 134 may have a mesh-type design. The mesh design may form any shape such as a square, diamond, triangle, and the like and may be any size or diameter as desired. As illustrated, the mesh-type design is formed of squares 136. However, this is not intended to be limiting as the mesh may form any shape such as a square, diamond, triangle, hexagonal, circular, oval, and the like. The radiator 134 may have a first edge 138 and a second edge 140 perpendicular to the first edge 138 and a first face 142 and a second face 144 opposite the first face 142, thereby forming an interior space 146 in the center of the radiator 134. The interior space 146 allows for the efficient and enhanced air flow through the radiator 134. In one example, the interior space 146 may have a width of between 0.5 inches to 20 inches.

The radiator 134 may also have hooks 148 attached to the first edge 138 and the second edge 140. The hooks 148 allow the radiator 134 to be removable from the interior of a trailer and repositioned in another trailer thereby allowing the radiator 134 to be portable and reusable. The radiator 134 may be removed from the trailers using any known device or apparatus that is capable of removing large and/or heavy objects, such as a crane. Although the hooks 148 are illustrated as being attached to the first edge 138 and second edge 140 of the radiator 134, this is not intended to be limiting as the hooks 148 may be positioned at any desired location for safe, efficient, and easy removal from a trailer. Additionally, any number of hooks may be used.

Although the radiators illustrated in FIG. 2 through FIG. 5 are illustrated as rectangular shaped, they are not intended to be limiting as the radiator may be any desired shape such as a triangle, rhombus, diamond, or an irregular formation. This allows the radiator to be custom designed to each trailer as desired by the user.

FIG. 6 and FIG. 7 illustrate example embodiments of a trailer 200 into which a nut dryer 202 has been installed. Referring first to FIG. 6, the nut dryer 202 may be placed within an interior opening 204 of the trailer housing 206 to receive nuts to be dried. Trailer 200 may be any known type of trailer capable of transporting produce such as nuts, fruits, and vegetables. As illustrated in this embodiment, trailer 200 may have a housing 206 coupled to a top side 208 of frame 210. The housing 206 may have a first side 212, and angled first side 214, a second side 216, and an angled second side 218. Although illustrated with angled sides 214, 218, this is not intended to be limiting as the trailer 200 may have sides of any desired shape, such as straight and perpendicular to the top side 208 of frame 210. A plurality of wheels 220 are coupled to a bottom side of frame 210. Trailer 200 may also have a hatch 222 having removable or slidable door(s) (not shown) to allow for easy of removal of produce from the interior opening 204 cavity of trailer 200.

FIG. 7 illustrates another example embodiment of a trailer 200 into which the nut dryer 202 has been installed. FIG. 7 is similar to FIG. 6, however, in one embodiment, the nut dryer 202 of height H1 may extend beyond the height H2 of housing 206. When the nuts or produce are loaded into the interior cavity 204 of trailer 200, the nuts may be filled beyond the height of the trailer to maximize a load. Thus, the additional height H1 of the nut dryer 202 is then able to accommodate the nuts extending beyond the height H2 of housing 206 and still allow air flow therethrough.

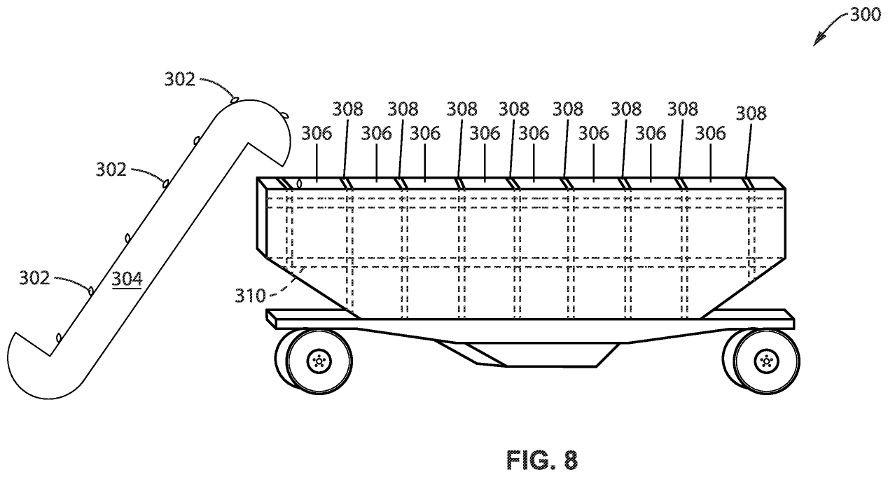

FIG. 8 illustrates an example embodiment 300 of loading nuts into a trailer having a nut dryer. Nuts are harvested and may be loaded in a cart (not illustrated) to be hauled to the trailer. The nuts 302 are then unloaded onto an elevator 304 having a movable conveyer belt. The conveyer belt on the elevator 304 moves the nuts 302 to be loaded to the openings 306 between each radiator 308 of the nut dryer 310 in the trailer. As the nuts are loaded into the openings 306, they are separated by radiators 308 to thereby allow for the flow of air therethrough. Although illustrated with a method of using a movable conveyer belt to load the trailer, this is not intended to be limiting as any known method of loading produce into the interior cavity of trailers may be used.

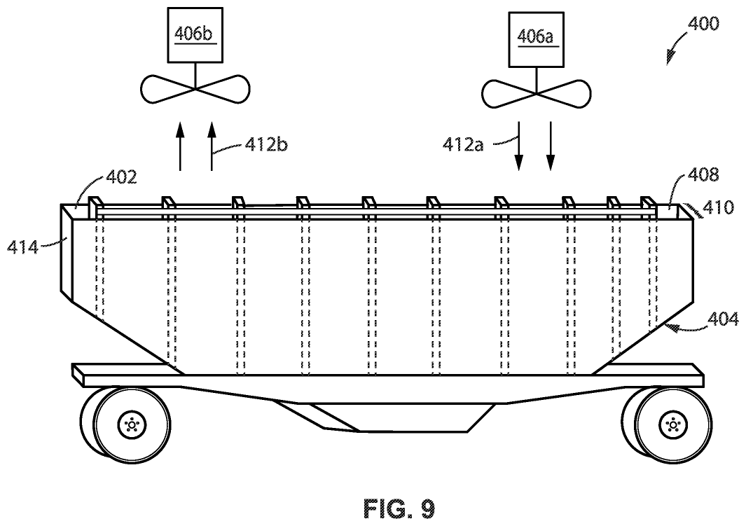

FIG. 9 is an illustration 400 of an example embodiment of drying nuts 402 loaded into the trailer 404. In one embodiment, the nuts 402 may be dried by placing the trailer 404 out in the sun. In another embodiment, air may be blown through the trailer to assist with drying of the nuts. In one example, air may be supplied using external air circulation devices, such as fans 406a, 406b. Although illustrated with two external 406a, 406b, this is not limiting as any desired number of fans may be used.

Air may be pushed into the interior cavity 408 of the trailer 404 at a first end 410 as illustrated by 412a. The air may then be pulled out at a second end 414 as illustrated by 412b. In another embodiment, air may be pushed into the interior cavity 408 and/or pulled out of the interior cavity 408.

Although described using an external fan, any device capable of blowing or circulating air may be used. Moreover, the air circulating through the interior cavity 408 of the trailer 404 may be at any desired temperature. For example, the temperature of the air being blown may be between about 0° F. to about 100° F.

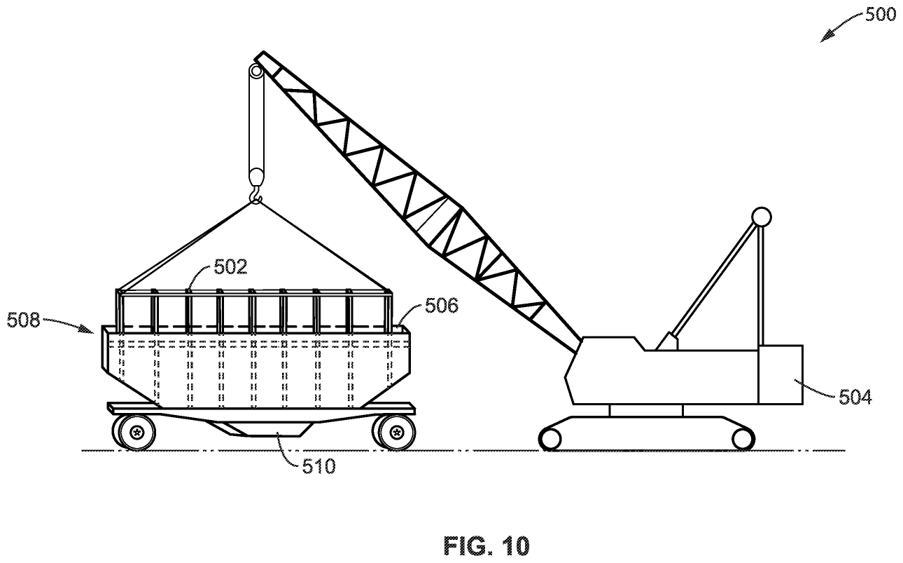

FIG. 10 is an illustration 500 of an example embodiment of a removable and reusable nut dryer 502. When the nuts are dried, the nut dryer 502 may be removed using any removal equipment or device, such as a crane 504. In one embodiment, nuts within the interior cavity 506 of the trailer 508 are unloaded via hatch 510 before nut drier 502 is removed from the trailer 508. Although any known method of removing large objects from cavities may be used, in this embodiment, hooks, such as hooks 148 (previously illustrated in FIG. 5, but not shown here), may be used to assist with the removal of nut dryer 502 from the trailer 508.

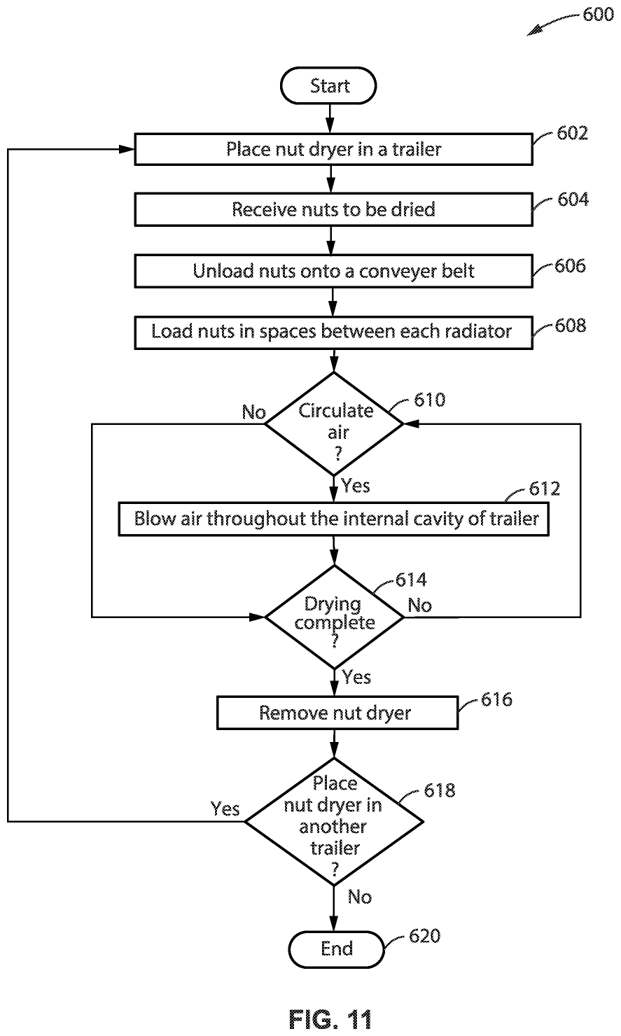

FIG. 11 illustrates an example method 600 for dying nuts according to the presented technology. The method 600 begins with placing a nut dryer in a trailer at 602. The nuts are then received in the trailer to be dried at 604. The nuts may be received in a cart filled with nuts to be dried and are then unladed onto a conveyer belt at 606. The conveyer belt loads the nuts in the spaces between the radiators at 608 the nuts to be loaded between each slat of the nut dryer in the trailer at 608.

A determination of whether to circulate air into or out of the trailer may be made at 610. Air may be pushed, pulled, or pushed and pulled into the interior cavity of the trailer. The air may be circulated throughout the interior cavity of the trailer at 612 using any air circulation devices, such as one or more fans.

If no air circulation is necessary at 610, the method 600 can continue to make a determination of whether drying is complete at 614. If the nuts are not dried at 614, the method 600 may continue at 610.

If it is determined that the nuts are dried at 614, the nut dryer may be removed from the trailer at 616. The nut dryer may be removed from trailer by any known methods using any device or equipment, including but not limited to a crane or lift. A determination is then made whether to place the nut dryer in another trailer at 618. If the nut dryer is to be placed into another trailer, the method 600 may continue at 602 and the nut dryer may be placed in another trailer. (Although not show here, the nuts are usually removed after this step.) If it is determined that the nut dryer is not to be placed in another trailer, the method 600 may end 620.

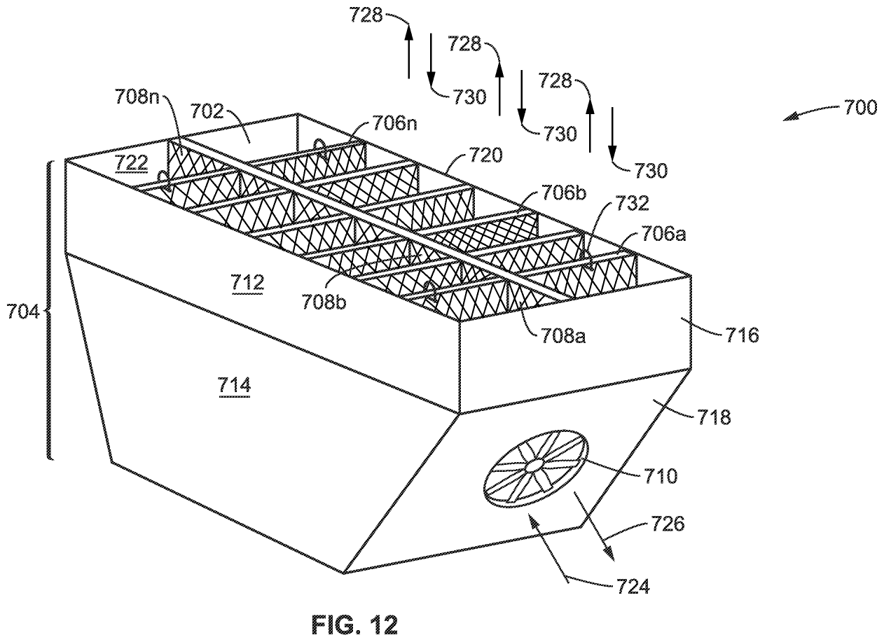

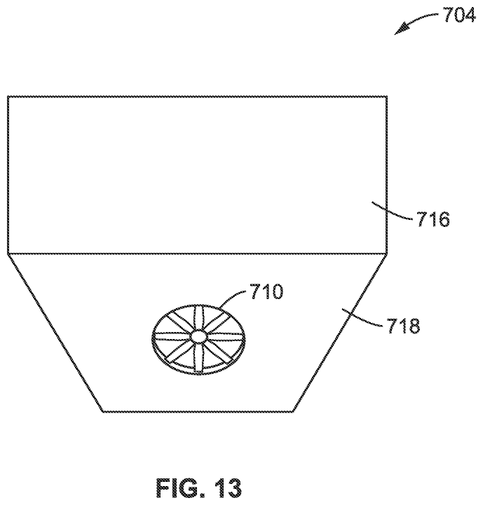

FIG. 12 and FIG. 13 illustrate another example embodiment of a nut dryer assembled in the interior cavity of a trailer. FIG. 12 is a 3D illustration of an embodiment of nut dryer 700 assembled in the interior cavity 702 of trailer 704. The nut dryer 700 may have a plurality of primary radiators 706a, 706b, . . . 706n and a plurality of secondary radiators 708a, 708b, . . . 708n that all aid in the drying of the foodstuffs emplaced in the interior cavity 702 of the trailer 704. An air circulating device 710, such as one or more fans, may be attached to the trailer 704. The trailer 704 may also have an upper front face 712, a bottom front face 714, an upper front side 716, a bottom front side 718, an upper rear face 720, a bottom rear face (not shown), an upper rear side 722, a bottom rear side (not shown). The upper front face 712, the bottom front face 714, the upper front side 716, the bottom front side 718, the upper rear face 720, the bottom front face (opposite from the bottom front face 714, but not otherwise shown), the upper rear side 722, and the bottom rear side (opposite from the bottom front side 718, but not otherwise shown) form the interior cavity 702 of the trailer 704. The air circulating device 710 is illustrated here as being coupled to the bottom front side 718.

The primary radiators 706a . . . 706n may extend from the upper front face 712 and upper front side 716 of the trailer 704 to the upper rear face 720 and upper rear side 722 of the trailer 700 in the interior cavity 702, respectively. The secondary radiators 708a . . . 708n may be perpendicular to and removably coupled to the primary radiators 706a . . . 706n and parallel to the upper front side 712 and upper rear side 720. In one embodiment, the primary radiators 706a . . . 706n may be one single, removable part. In another embodiment, as illustrated, the primary radiators 706a . . . 706n may be multiple removable parts. This allows for the flexibility for a user to from the nut dryer in any desired shape or design.

As illustrated, there may be an air circulating device 710 coupled to the bottom front side 718. Although illustrated with a single air circulating device 710, this is not intended to be limiting as any number of air circulating devices may be coupled to the trailer 704. For example, and not shown here, there may be two air circulating devices, one on the bottom rear side and another on the bottom front side 718. In another embodiment, air circulating devices may be placed throughout the trailer 704. For example, an air circulating fan may be coupled to the upper front side 712 and the upper rear side 722. In another example air circulating fans may be coupled to each of the bottom front face 714, upper front face 712, upper rear face 720, and bottom rear face. In still another example, eight air circulating fans may be positioned on the trailer 704, one each on the bottom front face 714, upper front face 712, upper rear face 720, bottom rear face, upper front side 716, bottom front side 718, upper rear side 722, and the bottom rear side.

The air circulating device 710 may direct air flow bidirectionally, either into 724, or out from 726 the trailer 704 interior cavity 702. Arrow 724 illustrates the flow of air through the trailer 704 from the bottom of the interior cavity 702 to exit 728 at the top of the interior cavity 702. Arrows 730 illustrates the air flow from the top of the interior cavity 702 to the bottom of the interior cavity 702 and out from 726 the interior cavity 702 through the air circulating device 710.

FIG. 13 illustrates an end view of the trailer 704 illustrated in FIG. 7A. As illustrated, the air circulating device 710 may be mechanically secured to the angled, bottom front side 718 of trailer 704. However, this is not intended to be limiting as the air circulating device 710 may be positioned in any surface of the housing of the trailer as discussed above in FIG. 12.

Lifting attachment points 732 allow for removal of the entire nut dryer 700 assembly, as shown in FIG. 12.

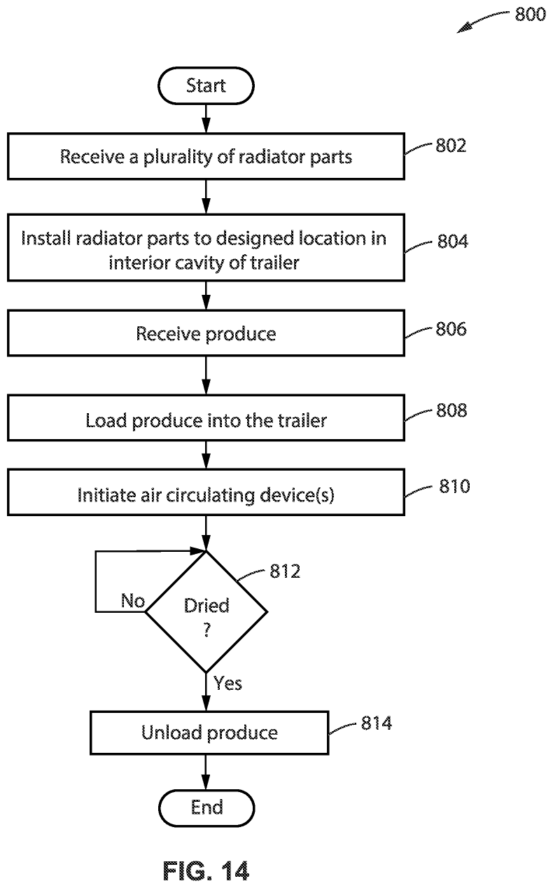

FIG. 14 illustrates an example method 800 for drying produce according to the presented technology. The method 800 may begin with receiving a plurality of radiator parts at 802. The radiator parts may be formed of any shape and are able to connect with each other through any known means to form any desired shape for the nut dryer, such as the nut dryer illustrated in FIG. 1 through FIG. 13. Once received, each radiator part may be installed in the desired shape or design within the interior cavity of the trailer at 804. In one embodiment, the nut dryer may be assembled prior to being installed in the interior cavity of the trailer. In another embodiment, the nut dryer may be assembled within the interior cavity of the trailer. Each of the plurality of radiator parts may be mechanically secured together through any known means such as with the use of various hardware or fastening members such as nuts and screws, other means may be through the use brackets, hinges, grooves, tracks, and other similar means or methods.

The produce may be received at 806 and loaded into the trailer at 808 between the spaces of the nut dryer. In step 810, air circulating devices may be initiated at to provide a flow of air through the interior cavity of the trailer to facilitate drying of the produce. The air circulation may be bidirectional. For example, air may be circulated and pulled into the interior cavity of the trailer at one end of the trailer and pushed out of the interior cavity of the trailer at another end of the trailer. In another embodiment, the air may be pushed into the interior cavity of the trailer from the top and out through the air circulating device at the bottom of the trailer. In another embodiment, the air may be pulled from the exterior environment into the air circulating device and out of the interior cavity at the top of the trailer.

A determination of whether the produce is sufficiently dried is made at 812. If the produce is not dried, the method returns to 812 to continue looping until the produce has been sufficiently dried. If the produce is sufficiently dried, the produce is unloaded at 814 through any known methods, such as the use of a hatch, such as hatch 222 illustrated in FIG. 6. The method 800 may then end.

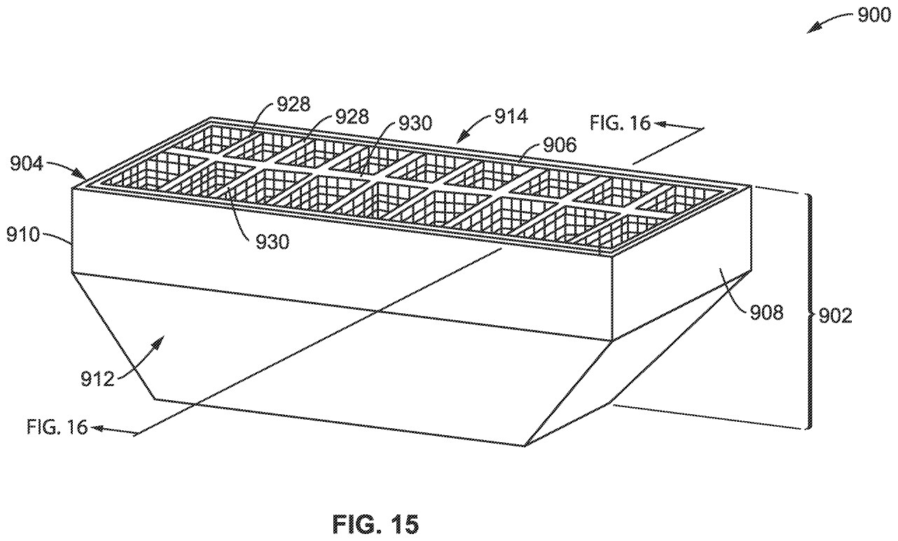

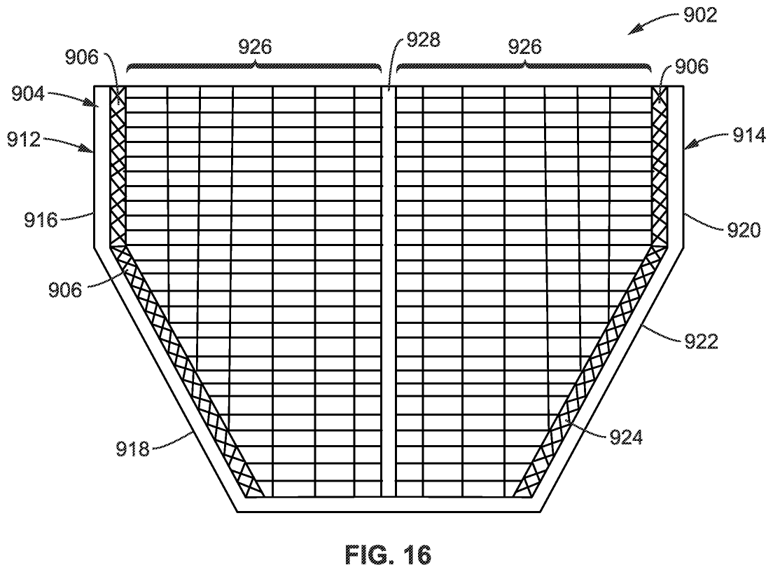

FIG. 15 and FIG. 16 illustrate yet another embodiment 900 of a nut dryer. Referring to FIG. 15, the nut dryer 902 is similar to the nut dryer 700 illustrated in FIG. 12. However, in this embodiment, the trailer 904 may have a plurality of perimeter radiators 906 positioned around the interior perimeter of the front side 908 and rear side 910, and front face 912 and rear face 914 of the nut dryer 902 to further enhance air flow through the interior cavity of trailer 904.

Referring now to FIG. 16, which is a cross sectional view of FIG. 15, showing that the front face 912 is comprised of upper front face 916 and the bottom front face 918. Similarly, rear face 914 is comprised of the upper rear face 920 and the bottom rear face 922. The perimeter radiators 906 may be formed from a mesh-like material and/or have a mesh-type design. The mesh design may form any shape such as a square, diamond, triangle, and the like, and may be any size or diameter as desired. As illustrated, the mesh-type design is formed of diamonds 924 along the perimeter radiators 906. However, this is not intended to be limiting as the mesh may form any shape such as a square, rhombus, triangle, and the like.

The perimeter radiators 906 may be similar to the radiators shown in FIG. 1 through FIG. 5 and have interior spaces 926 in the center of the perimeter radiator 906. The interior spaces 926 allow for the efficient and enhanced air flow through the perimeter radiators 906. In one example, the interior spaces 926 may have a width of between 0.5 inches to 20 inches.

The plurality of perimeter radiators 906 may be assembled and mechanically and removably attached to the primary radiators 928 and secondary radiators 930 through any known means such with the use of various hardware or fastening members such as nuts, bolts, and screws, as well as other means with the use of other fasteners, brackets, hinges, grooves, tracks, and other similar means or methods. The perimeter radiators 906 may also be mechanically and removably attached to the trailer 904 through similar means or methods as discussed above.

FIG. 16 illustrates a cross-sectional view of FIG. 15. The nut dryer 902 may have a plurality of perimeter radiators 906 positioned around the interior perimeter of the front side 908 and rear side 910, and front face 912 and rear face 914 of the nut dryer 902 to further enhance air flow through the interior cavity of trailer 904.

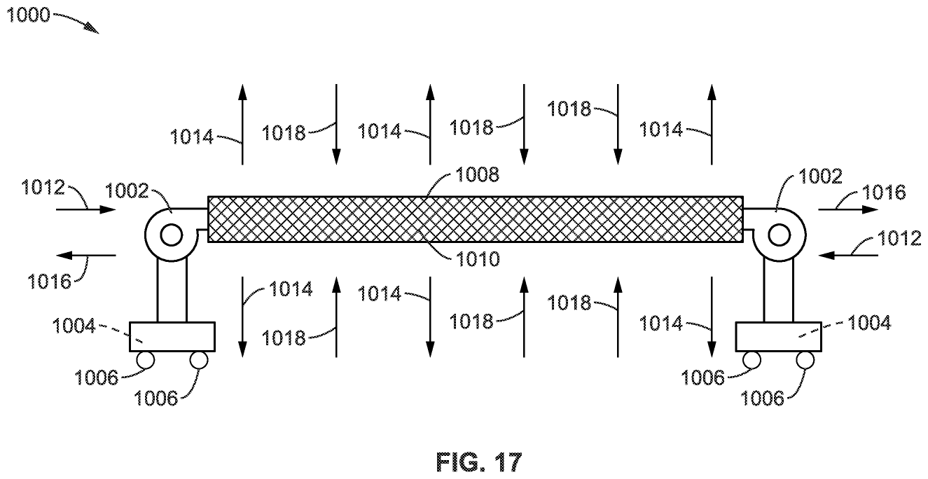

FIG. 17 illustrates an example embodiment of an on-ground aeration apparatus according to the presented technology. The aeration apparatus 1000 may have a plurality of air circulating devices 1002, such as a fan, positioned on a stand 1004. The stand 1004 may have a plurality of wheels 1006 to allow for mobility of the aeration apparatus 1000. However, the stand 1004 may also be a fixed stand without wheels 1006 to prevent the aeration apparatus 1000 from moving. A hollow tube 1008 may be positioned between air circulating devices 1002. The hollow tube 1008 may be formed of any known material able to withstand weighted force and weather, such as metal, plastic, steel, aluminum, PVC, and any other known materials. The hollow tube 1008 may be formed of any desired shape such as circular, triangular, rectangular, and the like. The hollow tube 1008 may have a mesh-type design 1010. The mesh design 1010 may form any shape such as a square, diamond, triangle, and the like and may be any size or diameter as desired.

As illustrated, the mesh-type design is formed of diamonds. However, this is not intended to be limiting as the mesh may form any shape such as a square, diamond, triangle, and the like. The hollow tube 1008 allows for the efficient and enhanced air flow provided by the air circulating devices 1002 without allowing the nuts or other produce from entering the hollow tube 1008. The width of the hollow tube 1008 may be any desired width. In one example, the hollow tube 1008 may have a width of about 1 inch to about 24 inches. In another example, the hollow tube 1008 may have a width of about 1 inch to about 48 inches.

In one embodiment, the air circulating devices 1002 may push incoming air 1012 through the center of the hollow tube 1008 as and out of the hollow tube 1008 illustrated by arrows 1014. As air enters the air circulating device 1002 (as indicated by arrows 1012, air may be pushed upward and downward through the hollow tube 1008 as illustrated by arrows 1014. In another embodiment, the air circulating devices 1002 may facilitate the pulling of air out of the center of the hollow tube 1008 as illustrated by arrows 1016. Air can be pulled into the hollow tube 1008 and out through the circulating device 1002 as illustrated by arrows 1018.

In another embodiment, the on-ground aeration apparatus may only have one air circulating device 1002 such that air can be pushed or pulled through the center of the hollow tube 1008 unidirectionally. In this embodiment, one side of the hollow tube 1008 may be closed or otherwise plugged (not shown) to prevent air from entering or exiting the one side.

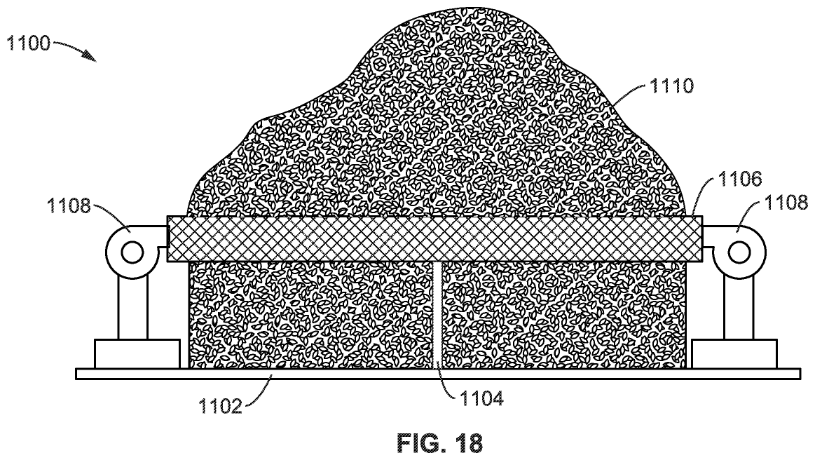

FIG. 18 illustrates an example use of the on-ground aeration apparatus of FIG. 17. In this embodiment, the on-ground aeration apparatus 1100 may be fixed onto a surface 1102 that provides protection from dirt and/or soil, such as concrete, tarp, or any other known similar surfaces. However, this is not intended to be limiting as the aeration apparatus 1100 may have wheels to allow for portability, as illustrated in FIG. 17. The on-ground aeration apparatus 1100 may also have at least one support member 1104 to provide support for hollow tube 1106. Any number of support members 1104 may be used as desired. The support member 1104 may be of any desired height and width. In one embodiment, the support member 1104 may have a height from the base of the on-ground aeration apparatus 1100 to the base of the hollow tube 1106. In one embodiment, the width of the support member 1104 may be between about 1 inch to about 5 inches. In another embodiment, the width of the support member 1104 may be between about 1 inch to about 15 inches.

The nuts or produce 1110 may be unloaded under and over the hollow tube 1106 of the aeration apparatus 1100, thereby forming a mound of the nuts or produce 1110. As explained in FIG. 10, air circulating devices 1108 may either push air into the hollow tube 1106 or pull air out of the hollow tube 1106, as desired by the user. The flow of air pushed or pulled through the nuts/produce facilitates the efficient drying of the nuts/produce to prevent spoilage of the nuts/produce as well as a quicker drying process.

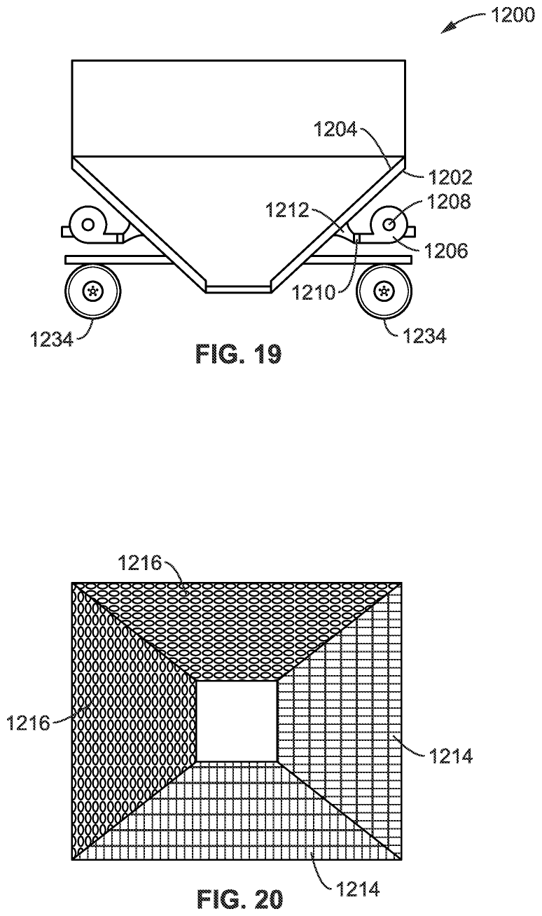

Refer now to FIG. 19 through FIG. 21. In FIG. 19, a side view of a trailer aeration system for natural almond drying is shown 1200 utilizing pulled (or pushed) aeration for foodstuff drying. Standard trailer inclined walls 1202 form an inclined floor of the standard trailer. Porous subfloors 1204 are placed over the inclined walls 1202, with the porous nature being achieved by perforated or meshed metal sheets. One or more pumps or fans 1206 have a pump inlet 1208, where air is pumped from the pump inlet 1208 to the pump outlet 1210.

A hose assembly 1212 through the wall that pulls or pushes air connects the pump outlet 1210 to the inclined walls 1202, allowing for air flow between the pump outlet 1210 and the porous subfloor 1204.

Referring now to FIG. 20, which is a top view of the trailer aeration system for natural almond drying 1200, an example of meshed inclined subfloor 1214 is seen, while on the other side, an example of a perforated inclined subfloor 1216 is seen.

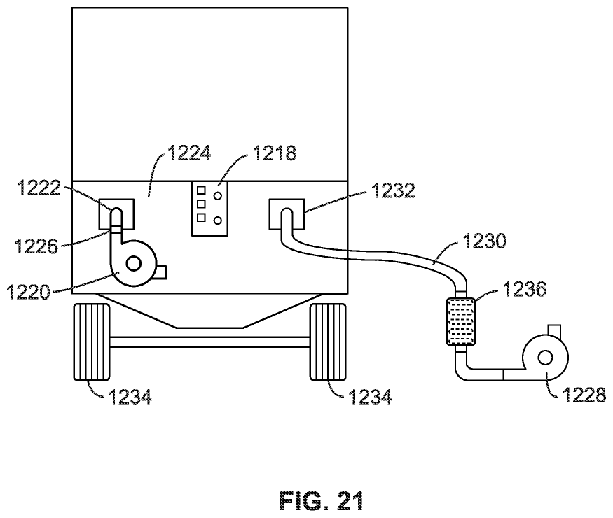

Referring now to FIG. 21, which is a front view of the trailer aeration system for natural almond drying 1200, where an assortment of components is seen. First, an electrical control box 1218 is used to control actuation of the pump or fan 1220 mounted on the trailer. An access 1222 is provided that allows passage through the wall 1224. Air is pushed or pulled through the hose 1226, connecting to the pump or fan 1220 to the access 1222.

In an alternate embodiment, an external pump or fan 1228 flows air through a hose 1230 to a second access 1232 on wall 1224 by either pushing or pulling air, as desired.

In FIG. 19 and FIG. 21, tires 1234 are shown as an option for transporting the trailer aeration system for natural almond drying 1200 from place to place.

In FIG. 21, an inline heater 1236 is provided to heat incoming air to aid the drying of the foodstuff as required by ambient conditions.

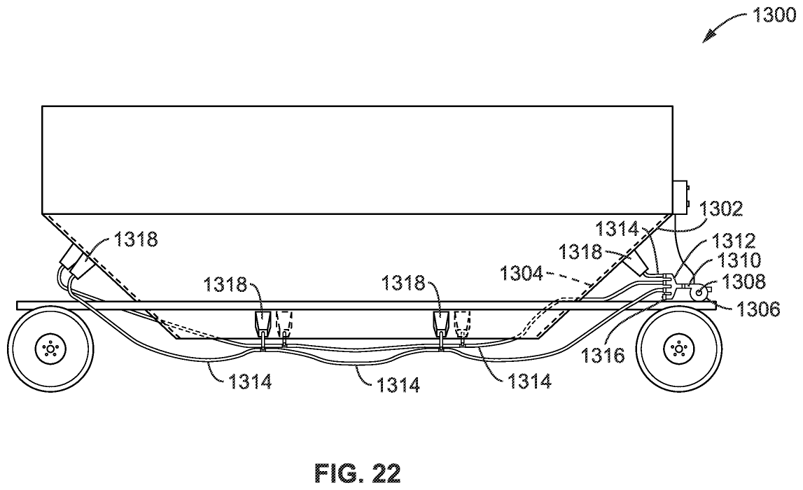

FIG. 22 closely resembles FIG. 19 except for the power source for the drying air flow. In FIG. 22, a side view of a trailer aeration system for natural almond drying is shown 1300 utilizing pulled (or pushed) aeration for foodstuff drying. Standard trailer inclined walls 1302 form an inclined floor of the standard trailer. Porous subfloors 1304 are placed over the inclined walls 1302, with the porous nature being achieved by perforated or meshed metal sheets. One or more pumps or fans 1306 have a pump inlet 1308, where air is pumped from the pump inlet 1308 to the pump outlet 1310.

The pump outlet 1310 is in turn connected to a manifold 1312. The manifold 1312 then connects to one or more aeration hoses 1314. As desired, the manifold 1312 may be capped 1316 if aeration hoses 1314 are not needed at the manifold 1312 port.

The aeration hoses 1314 connect to wall adapters 1318 that pass through the trailer inclined walls 1302 ultimately allowing the inflow or outflow of air between the pump outlet 1310 and the porous subfloor 1304.

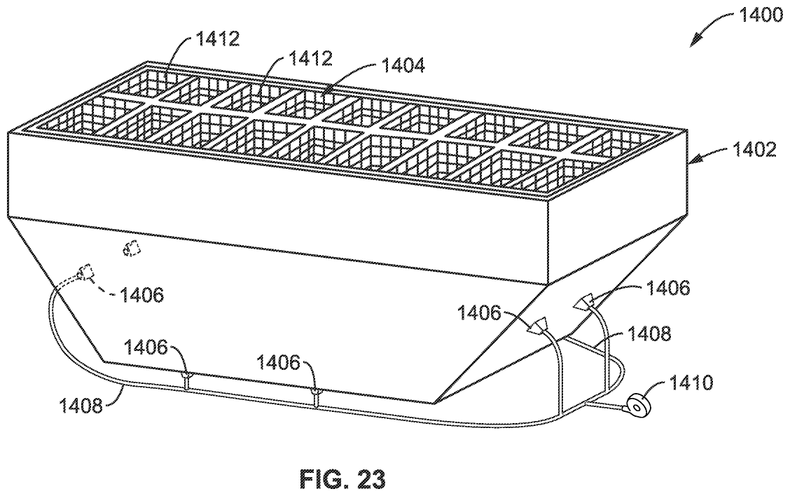

Refer now to FIG. 23, which is an illustration of a nut dryer 1400. Here, a trailer 1402 has a nut dryer 1404 disposed within. Attached to the trailer 1402 are one or more access ports 1406 that allow air access to the interior of the trailer 1402, while also providing a mesh (not shown) to prevent an inadvertent outflow of foodstuff from exiting the interior of the trailer 1402. One or more hoses 1408 work to interconnect the access ports 1406 and one or more fans 1410 to either push or air into or pull air out of the interior of the trailer 1402. In this embodiment, the trailer is shown as a ground mounted container without wheels, which may be attached as required.

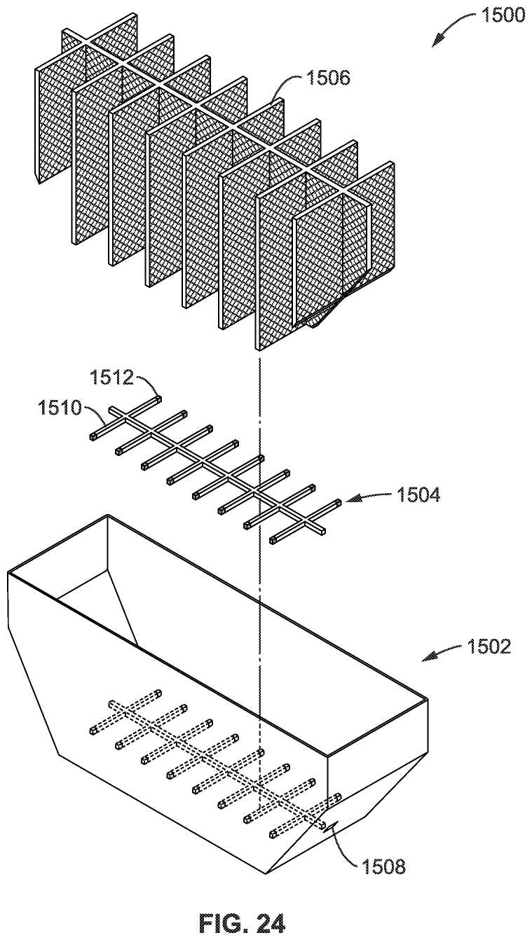

Refer now to FIG. 24, which is an exploded view of still another embodiment of a foodstuff drying apparatus 1500. In this embodiment, a trailer 1502 has emplaced on its floor a drying plenum 1504 below the nut dryer 1506. An aperture 1508 in the trailer 1502 allows air conveyance between the exterior of the trailer 1502 and the drying plenum 1504 in the assembled embodiment. The drying plenum 1504 may comprise a rectangular or square sequence of arms 1510 that terminate in drying vents 1512 that are configured to prevent inadvertent transfer of the foodstuff from elsewhere in the trailer 1502 into the drying plenum 1504 interior.

Although the drying plenum 1504 here is shown as a configuration similar to conventional air conditioning ducts, hoses may also be used, or more particularly semi rigid (wired flexible) hoses that would not otherwise be crushed by foodstuff emplaced within the trailer 1502. In another embodiment, the drying plenum 1504 may be a rectangular, or any other desired shaped, floor disposed below the nut dryer 1506 so as to form an open space (i.e., no foodstuff) thereby allowing air to flow below the nut dryer 1506.

In yet another embodiment, the trailer may have a single or multiple pipes (as opposed to radiators previously described) inside the trailer. This internal piping system is similar to the on-ground pipe system previously described; however, the pipe system is instead placed inside the trailer. Blowers, fans, or pumps may then be used to blow air into or out of the trailer.

As described above, the term radiator has been used somewhat differently that that of a standard radiation heat transfer device. In this application, the radiator combines the function of a foodstuff separator, keeping the foodstuff on one side, while simultaneously allowing the flow of air on the other side.

The air supplied to the radiators may be ambient air if conditions are correct, or may be warmed or heated by a heat source to dry the foodstuff in the trailer.

The on-ground system air flow typically has a lower air flow rate than the trailer, when measured in Cubic Feet Per Minute (CFM). The trailer would likely benefit from several pumps with increased flow capacity (i.e., several pumps of 100 or 500 cfm or a combination of 100 cfm and 500 cfm pumps) and the subfloor.

Testing of the on-ground system produced the following results:
1) 5 tons of almonds required 3 days to dry to a moisture level of 13-21% using 2 centrifugal pumps with 150 cfm pumping air out of the system. This test was conducted at the end of August in California.
2) 10 tons of almonds required 8 days to dry to a moisture level of 15-29% using same pumps as above. The test was conducted in mid-October, also in California.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

An apparatus for drying foodstuff, the apparatus comprising: (a) a support frame, said support frame comprising a plurality of spaced apart support rails, said support frame having a first end and a second end; (b) a plurality of radiator panels, said radiator panels coupled to said support rails and positioned therebetween, said radiator panels spaced apart between the first and second ends of the support frame to form compartments between the radiator panels; (c) said radiator panels having openings through which air can flow; (d) said support frame and radiator panels configured to be placed within a container; (e) said support frame and radiator panels configured for filling the compartments with foodstuff when installed in said container.

An apparatus for drying foodstuff, the apparatus comprising: (a) a support frame, said support frame comprising a plurality of spaced apart support rails, said support frame having a first end and a second end; (b) a plurality of radiator panels, said radiator panels coupled to said support rails and positioned therebetween, said radiator panels spaced apart between the first and second ends of the support frame to form compartments between the radiator panels; (c) said radiator panels having openings through which air can flow; (d) said support frame and radiator panels positioned within a container; (e) said support frame and radiator panels configured for filling the compartments with foodstuff.

A method for drying foodstuff, the method comprising: (a) providing a drying apparatus, the drying apparatus comprising: (i) a support frame, said support frame comprising a plurality of spaced apart support rails, said support frame having a first end and a second end; (ii) a plurality of radiator panels, said radiator panels coupled to said support rails and positioned therebetween, said radiator panels spaced apart between the first and second ends of the support frame to form compartments between the radiator panels; (iii) said radiator panels having openings through which air can flow; (b) positioning said support frame and radiator panels within a container, said support frame and radiator panels configured for filling the compartments with foodstuff; when installed in said container; (c) filling the compartments with foodstuff; and (d) allowing air to circulate among the foodstuff to dry the foodstuff.

A method for drying foodstuff, the method comprising: (a) providing a drying apparatus, the drying apparatus comprising: (i) a hollow tube comprising meshed openings, said hollow tube having a first end, and said tube disposed above a surface; (ii) a first air circulating device that produces a first output air flow, said air circulating device fluidly coupled to said hollow tube at its first end; (iii) a first stand, whereupon said first air circulating device is supported above said surface; (iv) a second air circulating device that produces a second output air flow, said second air circulating device fluidly coupled to said hollow tube at a second end of said hollow tube; (v) a second stand, whereupon said second air circulating device is supported above said surface; (vi) zero or more support members that provide additional support to the hollow tube above the surface despite a dynamic or static load of foodstuff mounded above and around the hollow tube; (vii) wherein said first and second air circulating devices cause air to flow through said hollow tube and through said mounded foodstuff; (b) mounding foodstuff above and around the hollow tube; and (c) allowing air to circulate through the hollow tube, and among the foodstuff to dry the foodstuff.

An apparatus for drying foodstuff, the apparatus comprising: (a) a hollow tube comprising meshed openings, said hollow tube having a first end, and said tube disposed above a surface; (b) a first air circulating device that produces a first output air flow, said air circulating device fluidly coupled to said hollow tube at its first end; (c) a first stand, whereupon said first air circulating device is supported above said surface; (d) a second air circulating device that produces a second output air flow, said second air circulating device fluidly coupled to said hollow tube at a second end of said hollow tube; (e) a second stand, whereupon said second air circulating device is supported above said surface; (f) zero or more support members that provide additional support to the hollow tube above the surface despite a dynamic or static load of foodstuff mounded above and around the hollow tube; (g) wherein said first and second air circulating devices cause air to flow through said hollow tube and through said mounded foodstuff.

The apparatus or method of any preceding or following implementation, wherein said container is selected from the group consisting of stationary containers, moveable containers, trailer containers, above-ground containers, and containers with sidewalls through which air can flow.

The apparatus or method of any preceding or following implementation, wherein the foodstuff comprises produce selected from the group consisting of nuts, fruits, and vegetables.

The apparatus or method of any preceding or following implementation, wherein said openings in the radiator panel are selected from the group consisting of holes, slits, apertures in mesh, apertures in a wire frame, and other apertures.

The apparatus or method of any preceding or following implementation, wherein the radiator panel comprises a mesh frame comprising an interior space.

The apparatus or method of any preceding or following implementation: wherein the apparatus is a component of a container; and wherein said container is selected from the group consisting of moveable containers, trailer containers, above-ground containers, and containers with sidewalls through which air can flow.

The apparatus or method of any preceding or following implementation: further comprising a plenum disposed within said container, configured to flow air from outside the container to said radiator panels.

The apparatus or method of any preceding or following implementation: wherein said meshed openings in the hollow tube are selected from the group consisting of holes, slits, apertures in mesh, apertures in a wire frame, and other apertures.

The apparatus or method of any preceding or following implementation further comprising two or more wheels on said first and second stands, whereby said apparatus may be moved over said surface.

The apparatus or method of any preceding or following implementation: wherein the hollow tube is configured to flow air from outside ambient air to said hollow tube, or where the hollow tube is configured to flow air from said mounded produce to outside ambient air.

The apparatus or method of any preceding or following implementation: wherein said meshed openings in said hollow tube are selected from the group consisting of holes, slits, apertures in mesh, apertures in a wire frame, and other apertures.

The apparatus or method of any preceding or following implementation: wherein the hollow tube is configured for flowing air from outside ambient air to said hollow tube, or where the hollow tube is configured for flowing air from said mounded produce to outside ambient air.

The apparatus or method of any preceding or following implementation: wherein the air flowing from the outside ambient to said hollow tube is heated.

The apparatus or method of any preceding or following implementation: wherein the foodstuff comprises produce selected from the group consisting of nuts, fruits, and vegetables; wherein said openings in the radiator panel are selected from the group consisting of holes, slits, apertures in mesh, apertures in a wire frame, and other apertures; and wherein the radiator panel comprises a mesh frame comprising an interior space; and further comprising a plenum disposed within said container, configured to flow air from outside the container to said radiator panels.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for drying foodstuff, the apparatus comprising:
(a) a hollow tube comprising meshed openings, said hollow tube having a first end, and said tube disposed above a surface;
(b) a first air circulating device that produces a first output air flow, said air circulating device fluidly coupled to said hollow tube at its first end;
(c) a first stand, whereupon said first air circulating device is supported above said surface;
(d) a second air circulating device that produces a second output air flow, said second air circulating device fluidly coupled to said hollow tube at a second end of said hollow tube;
(e) a second stand, whereupon said second air circulating device is supported above said surface;
(f) zero or more support members that provide additional support to the hollow tube above the surface despite a dynamic or static load of foodstuff mounded above and around the hollow tube;
(g) wherein said first and second air circulating devices cause air to flow through said hollow tube and through said mounded foodstuff.

2. The apparatus of claim 1, wherein the foodstuff comprises produce selected from the group consisting of nuts, fruits, and vegetables.

3. The apparatus of claim 1, wherein said meshed openings in the hollow tube are selected from the group consisting of holes, slits, apertures in mesh, apertures in a wire frame, and other apertures.

4. The apparatus of claim 1, further comprising two or more wheels on said first and second stands, whereby said apparatus may be moved over said surface.

5. The apparatus of claim 1, wherein the hollow tube is configured to flow air from outside ambient air to said hollow tube, or where the hollow tube is configured to flow air from said mounded produce to outside ambient air.

6. A method for drying foodstuff, the method comprising:
(a) providing a drying apparatus, the drying apparatus comprising:
(i) a hollow tube comprising meshed openings, said hollow tube having a first end, and said tube disposed above a surface;
(ii) a first air circulating device that produces a first output air flow, said air circulating device fluidly coupled to said hollow tube at its first end;
(iii) a first stand, whereupon said first air circulating device is supported above said surface;
(iv) a second air circulating device that produces a second output air flow, said second air circulating device fluidly coupled to said hollow tube at a second end of said hollow tube;
(v) a second stand, whereupon said second air circulating device is supported above said surface;
(vi) zero or more support members that provide additional support to the hollow tube above the surface despite a dynamic or static load of foodstuff mounded above and around the hollow tube;
(vii) wherein said first and second air circulating devices cause air to flow through said hollow tube and through said mounded foodstuff;
(b) mounding foodstuff above and around the hollow tube; and
(c) allowing air to circulate through the hollow tube, and among the foodstuff to dry the foodstuff.

7. The method of claim 6, wherein the foodstuff comprises produce selected from the group consisting of nuts, fruits, and vegetables.

8. The method of claim 6, wherein said meshed openings in said hollow tube are selected from the group consisting of holes, slits, apertures in mesh, apertures in a wire frame, and other apertures.

9. The method of claim 6, wherein the hollow tube is configured for flowing air from outside ambient air to said hollow tube, or where the hollow tube is configured for flowing air from said mounded produce to outside ambient air.

10. The method of claim 9, wherein the air flowing from the outside ambient to said hollow tube is heated.

11. An apparatus for drying foodstuff, the apparatus comprising:
(a) a support frame, said support frame comprising a plurality of spaced apart support rails, said support frame having a first end and a second end;
(b) a plurality of radiator panels, said radiator panels coupled to said support rails and positioned therebetween, said radiator panels spaced apart between the first and second ends of the support frame to form compartments between the radiator panels;
(c) said radiator panels having openings through which air can flow;
(d) said support frame and radiator panels configured to be placed within a container;
(e) said support frame and radiator panels configured for filling the compartments with foodstuff when installed in said container.

12. The apparatus of claim 11, wherein said container is selected from the group consisting of stationary containers, moveable containers, trailer containers, above-ground containers, and containers with sidewalls through which air can flow.

13. The apparatus of claim 11, wherein the foodstuff comprises produce selected from the group consisting of nuts, fruits, and vegetables.

14. The apparatus of claim 11, wherein said openings in the radiator panel are selected from the group consisting of holes, slits, apertures in mesh, apertures in a wire frame, and other apertures.

15. The apparatus of claim 11, wherein the radiator panel comprises a mesh frame comprising an interior space.

16. The apparatus of claim 11:
wherein the apparatus is a component of the container; and
wherein said container is selected from the group consisting of moveable containers, trailer containers, above-ground containers, and containers with sidewalls through which air can flow.

17. The apparatus of claim 11, further comprising a plenum disposed within said container, configured to flow air from outside the container to said radiator panels.

18. An apparatus for drying foodstuff, the apparatus comprising:
(a) a support frame, said support frame comprising a plurality of spaced apart support rails, said support frame having a first end and a second end;
(b) a plurality of radiator panels, said radiator panels coupled to said support rails and positioned therebetween, said radiator panels spaced apart between the first and second ends of the support frame to form compartments between the radiator panels;
(c) said radiator panels having openings through which air can flow;
(d) said support frame and radiator panels positioned within a container;
(e) said support frame and radiator panels configured for filling the compartments with foodstuff.

19. The apparatus of claim 18, wherein said container is selected from the group consisting of stationary containers, moveable containers, trailer containers, above-ground containers, and containers with sidewalls through which air can flow.

20. The apparatus of claim 18:
wherein the foodstuff comprises produce selected from the group consisting of nuts, fruits, and vegetables;
wherein said openings in the radiator panel are selected from the group consisting of holes, slits, apertures in mesh, apertures in a wire frame, and other apertures; and
wherein the radiator panel comprises a mesh frame comprising an interior space; and
further comprising a plenum disposed within said container, configured to flow air from outside the container to said radiator panels.
